(19) United States
(12) Patent Application Publication
(10) Pub. No.: US 2009/0069060 A1
(43) Pub. Date: Mar. 12, 2009

(54) CLIP-ON WIRELESS DEVICE WITH RETRACTABLE EAR PIECE

(76) Inventor: Young S. Kim, Los Altos, CA (US)

Correspondence Address: Dorsey & Whitney LLP;US Bank Center, 1420 Fifth Avenue, Suite 3400, Seattle, WA, 98101-4010, US

(21) Appl. No.: 11/853,733

(22) Filed: Sep. 11, 2007

(51) Int. Cl. H04M 1/02

(52) U.S. Cl. 455/575.6

(57) ABSTRACT

A clip-on wireless device for use with a mobile communications device by an operator wearing an article of upper-body clothing. The device includes a body having a housing and a clip connected to the housing. The body is light-weight so as to permit the body to the carried on the article of clothing by the clip. An integrated circuit is carried within the housing and includes radio communications circuitry for communicating with the mobile communications device. An earpiece is included and a cable connects the earpiece to the circuitry within the body. A spring and reel mechanism inside the housing retracts the cable into the housing when the earpiece is not in use.

### FIELD OF THE INVENTION

The present invention relates generally to a wireless device and more particularly to a wireless radio communications device for communicating with a mobile communications device.

### BACKGROUND INFORMATION

In today's mobile society, an increasingly large number of individuals carry mobile communication devices such as cell phones. A common accessory for use with such a mobile communications device is a radio communications device such as a Bluetooth device for permitting hands-free communication over the mobile communications device. Many of such Bluetooth devices facilitate listening over a mobile communications device by having an earpiece that seats within the ear of the user, but are configured to be mounted on the ear and thus suffer from being unsightly and uncomfortable to the user.

There is, therefore, a need for a radio communications device that includes an earpiece for facilitating listening but that does not mount on the ear of the user.

### SUMMARY OF THE INVENTION

A clip-on wireless device for use with a mobile communications device by an operator wearing an article of upper-body clothing is provided. The device includes a body having a housing and a clip connected to the housing. The body is light-weight so as to permit the body to the carried on the article of clothing by the clip. An integrated circuit is carried within the housing and includes radio communications circuitry for communicating with the mobile communications device. An earpiece is included and a cable connects the earpiece to the circuitry within the body. A spring and reel mechanism inside the housing retracts the cable into the housing when the earpiece is not in use.

### BRIEF DESCRIPTION OF THE DRAWINGS

The accompanying drawings, which are somewhat schematic in some instances and are incorporated in and form a part of this specification, illustrate several embodiments of the invention and, together with the description, serve to explain the principles of the invention.

FIG. 1 is a front perspective view of the clip-on wireless device with retractable ear piece of the present invention docked in a base.

FIG. 2 is a rear perspective view of the clip-on wireless device with retractable ear piece and base of FIG. 1 taken along the line 2-2 of FIG. 1.

FIG. 3 is a front perspective view of the clip-on wireless device with retractable ear piece of FIG. 1 separated from the base of FIG. 1

FIG. 4 is a perspective view of the base of FIG. 1 taken along the line 4-4 of FIG. 3.

FIG. 5 is a bottom and rear perspective view of the clip-on wireless device with retractable ear piece of FIG. 1 taken along the line 5-5 of FIG. 3.

FIG. 6 is a front perspective view of the clip-on wireless device of FIG. 1 separated from the dock of FIG. 1 and having the earpiece extending from the device.

FIG. 7 is a side perspective view of the clip-on wireless device of FIG.1 having the earpiece extending from the device.

FIG. 8 is a schematic view of the rear of the clip-on wireless device of FIG. 1, partially cut away to reveal a spring and reel mechanism for retracting the cable attached to the ear piece in to the device.

### DETAILED DESCRIPTION OF EMBODIMENTS OF THE INVENTION

In one embodiment of the present invention, a clip-on wireless device 11 is provided that can be used with a mobile communications device such as a cell phone for facilitating hands free operation of the mobile communications device.

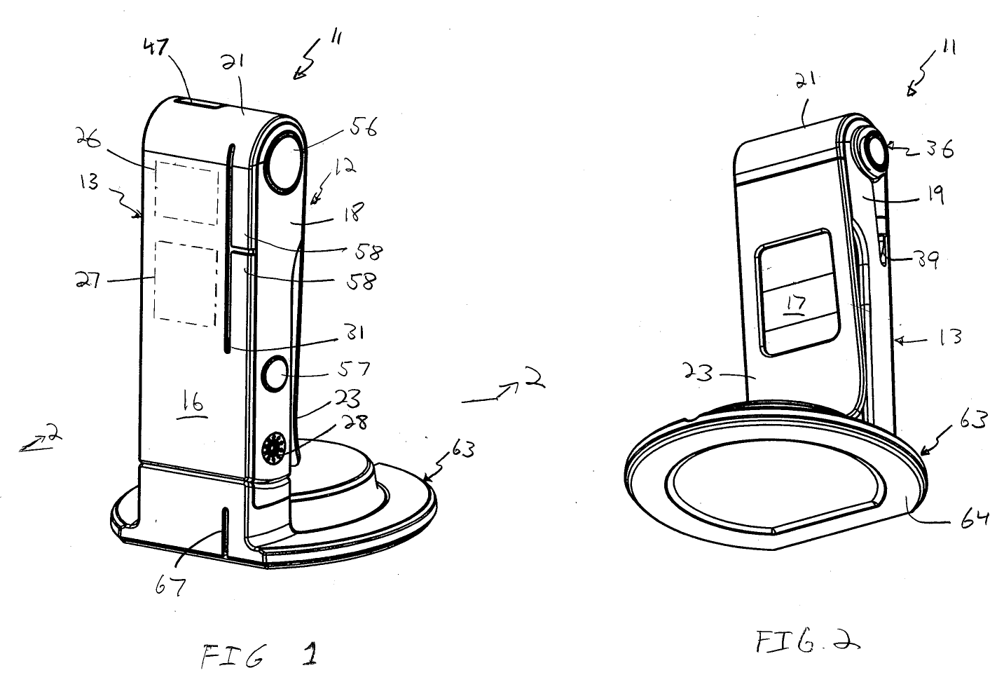

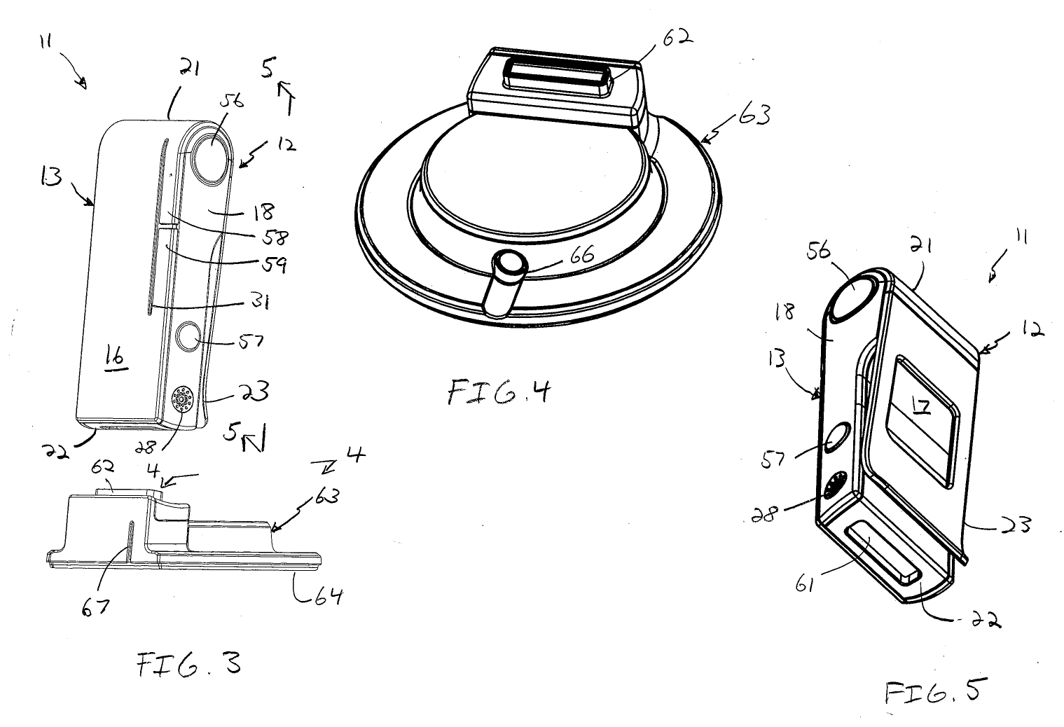

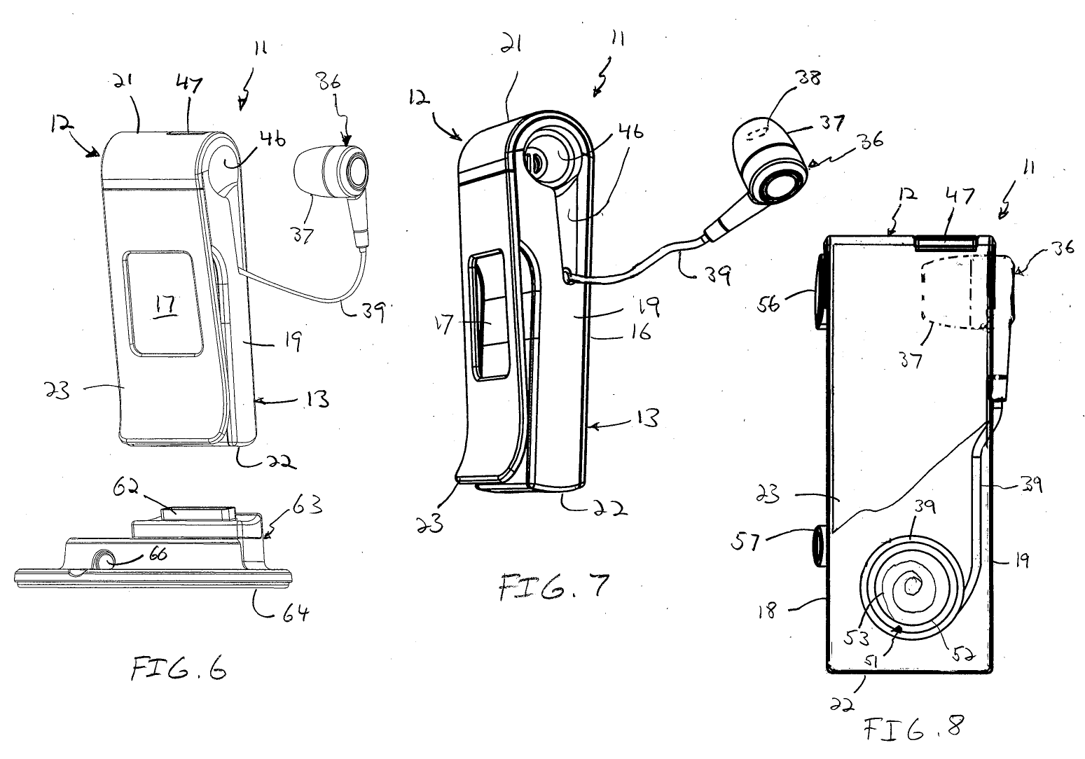

Clip-on wireless device 11 has a body 12 formed from a housing 13 made from any suitable material such as plastic or metal (see FIGS. 1-3 and 5). In one embodiment the housing 13 is made from metal and has a front surface 16 and a rear surface 17 extending substantially parallel to the front surface 16. A first side surface 18 and a second side surface 19 extend between front and rear surfaces 16 and 17 and are preferably substantially perpendicular to the surfaces 16 and 17 and substantially parallel to each other. Body 12 further includes a rounded upper end 21 and an opposite lower end 22. A clip 23 is included in body 12. The clip is joined to the housing 13 at the upper end 21 of the body and extends downwardly over, and is spaced apart from, front surface 16. Clip 23 and housing 13 are configured so as to permit body 12 to be secured to an article of clothing (not shown), for example to a pocket, lapel, loop or other edge of the article of clothing. Body 12 is sufficiently lightweight and sized so that the body 12 can hang on such article of clothing by the clip 23 without tearing the article of clothing or falling off the article of clothing. In this regard, the body 12 can be of any suitable weight and in one preferred embodiment is approximately 30 grams in weight. In one embodiment, body 12 is elongate and thumb-sized, that is has a size and shape approximating the size and shape of a human thumb, and in one preferred embodiment has a height of approximately 62 millimeters, a width between side surfaces 18 and 19 of approximately 26 millimeters and a thickness between front surface 16 and clip 23 of approximately 16 millimeters. As such, body 12 can also be carried by a user in a pocket of an article of clothing.

Device 11 includes at least one integrated circuit 26 and a battery 27 for powering integrated circuit 26. Integrated circuit and battery 27 are shown schematically in dashed lines in FIG. 1. The integrated circuit or module 26 is electrically coupled to battery 27 and includes radio communication circuitry for permitting clip-on wireless device 11 to communicate short wave with a mobile communications device such as a cell phone (not shown). One suitable standard for use in such short wave radio communications is Bluetooth, an industrial specification for wireless personal area networks developed and licensed by the Bluetooth Special Interest Group headquartered in Bellevue, Wash. A speaker 28 or other suitable signaling device or indicator is carried by housing 13 for signaling the arrival of an in-coming call on the associated mobile communications device to which clip-on wireless device 11 has been programmed for use. In one embodiment, speaker 28 is provided on first side surface 18 adjacent lower end 22 of the body 12 (see FIG. 1). Wireless device 11 includes a microphone 31, for example provided on the exterior of housing 13 and in one embodiment provided on the front surface 16 of the housing, that is electrically coupled to integrated circuit 26 for permitting outgoing voice communications on wireless device 11 by the user.

Clip-on wireless device further includes an earpiece or earbud 36 having a portion 37 configured for seating within a human ear. In one preferred embodiment, portion 37 has a substantially truncated conical shape and is made from any suitable elastic material such as plastic or rubber. A speaker 38, shown schematically in FIG. 7, is provided within portion 37 and is electrically coupled by any suitable means such as a cable 39 to integrated circuit 26 within housing 13. Microphone 31 and earpiece 36 form a headset for permitting two-way communications between clip-on wireless device 11 and the associated mobile communications device.

Housing 13 is provided with a recess 46 for seating earpiece 36. In one embodiment, recess 46 is provided in the second side surface 19 of the housing. The recess is sized to permit the earpiece to seat substantially entirely within the confines of the housing when the earpiece is not in use. In this regard, for example, the earpiece 36 preferably seats substantially flush with second side surface 19 when the earpiece is disposed within recess 46 (see FIGS. 2 and 8). It is preferred that at least portion 37 be seated entirely within the housing 13 and that any portion of the earpiece protruding from housing 13 not detract from the overall profile of the housing. A suitable locking mechanism (not shown) is provided on body 12 for securing the earpiece 36 within recess 46. A release button 47 is provided on upper end 21 of the housing 13 for releasing the locking mechanisms and thereby permitting the release of earpiece 36 from body 12 and preferable ejecting the earpiece from the recess 46.

A spring and reel mechanism 51 is provided inside housing 13 for reeling in the slack in cable 36 during use and reeling the cable 39 entirely into housing 13 when earpiece 36 is seated within recess 46 and thus not in use. The spring and reel mechanism 51, shown schematically in FIG. 8, can be of any conventional type and in one embodiment includes a reel 52 around which cable 39 can be wound and a spring 53 which when released causes the reel 52 to rotate and thus wind cable 39 into the housing 13. A conventional locking mechanism (not shown) is included in the spring and reel mechanism for selectively locking the cable when the cable is withdrawn from the housing to a desired length to permit the earpiece to be comfortably placed in the ear of the user. Such locking mechanism can be released in any suitable manner, for example by tugging slightly on the cable, to cause the cable 39 to be wound onto reel 52 by the urging of spring 53 and thus retract the cable into the housing.

Device 11 further includes additional operating features such as a take-call button 56 for activating the device 11 when it is desired to receive a call through the device 11 and a hold button 57 for placing on hold a call received by the device 11. In one embodiment, take-call button 56 is provided on first side surface 18 at upper end 21 and the hold button 57 is provided on the lower portion of the first side surface 18 between the take-call button 56 and speaker 28. Housing 13 is formed with adjacent first and second volume buttons 58 and 59 for respectively increasing and decreasing the volume of the call received through clip-on wireless device 11. In the illustrated embodiment, volume buttons 58 and 59 are provided on front surface 16 so as to be accessible when the device 11 is clipped onto a garment.

A recessed electrical connector 61 is provided on lower end 22 of the body 12 for cooperatively receiving an upstanding electrical connector 62 provided on a base or cradle 63. Electrical connector 61 communicates with battery 27 and optionally integrated circuit 26. In one embodiment, base 63 is circular in shape and provided with a lower planar surface 64 for engaging a planar support surface (not shown). The upstanding electrical connector 62 of base 63 is electrically coupled to a charging cord connector 66 provided on the base and suitable for electrically coupling to a recharging cord. An optional LED light 67 is provided on cradle 63 for indicating when clip-on a wireless device 11 docked with the cradle by means of connectors 61 and 62 is being charged by power provided by through recharging connector 66.

In operation and use, light-weight wireless device 11 can be clipped onto an article of clothing worn by a user, and preferably an article of upper-body clothing so as to be located near the head and ear of the user. When a call is received by a mobile communications device carried by the user, for example in the pocket of the user, speaker 28 indicates the arrival of the call. The user thereafter presses release button 47 so as to eject or otherwise release earpiece 36 from the body 12 and then places portion 37 of the earpiece within the ear of the user. Before or after such placement of earpiece 36, take-call button 56 is pressed so as to receive the call through the wireless device 11. When the earpiece 36 is properly placed within the user's ear, the user can communicate through the mobile communications device by means of the microphone 31 and earpiece 36 of the wireless device 11. Upon termination of the call, the user can withdraw earpiece 36 from the ear and release the locking mechanism of the spring and reel mechanism; for example by tugging slightly on the cable 39, so as to cause the cable 39 to retract into housing 13. The earpiece 36 is then returned to the recess 46 and locked therein for storage during nonuse. In this manner, clip-on wireless device 11 permits a mobile communications device user to more easily communicate in a hands free mode without the need of an earpiece clipped onto the user's ear both during and between communications.

The foregoing descriptions of specific embodiments and best mode of the present invention have been presented for purposes of illustration and description only. They are not intended to be exhaustive or to limit the invention to the precise forms disclosed. Specific features of the invention are shown in some drawings and not in others, for purposes of convenience only, and any feature may be combined with other features in accordance with the invention. Steps of the described processes may be reordered or combined, and other steps may be included. The embodiments were chosen and described in order to best explain the principles of the invention and its practical application, to thereby enable others skilled in the art to best utilize the invention and various embodiments with various modifications as are suited to the particular use contemplated. Further variations of the invention will be apparent to one skilled in the art in light of this disclosure and such variations are intended to fall within the scope of the appended claims and their equivalents.

What is claimed is:

1. A clip-on wireless device for use with a mobile communications device by an operator wearing an article of upper-body clothing comprising a body having a housing and a clip connected to the housing, the clip being adapted for attaching the body to the article of clothing, the body being light-weight so as to permit the body to the carried on the article of clothing by the clip, an integrated circuit carried within the housing and including radio communications circuitry for communicating with the mobile communications device, an earpiece, a cable connecting the earpiece to the circuitry within the body and a spring and reel mechanism inside the housing for retracting the cable into the housing when the earpiece is not in use.

2. The device of claim 1 wherein housing is provided with a recess of receiving the earpiece when the cable is retracted into the housing and the earpiece is not in use.

3. The device of claim 3 wherein the recess is sized to permit the earpiece to seat entirely within the confines of the housing when the earpiece is not in use.

4. The device of claim 1 wherein the body is provided with a microphone connected to the integrated circuit.

5. The device of claim 1 wherein the body is thumb-sized.

6. The device of claim 5 wherein the body has front and rear substantially parallel surfaces and first and second substantially parallel side surfaces extending between the front and rear surfaces.

7. The device of claim 6 wherein the recess is provided in the first side surface.

8. The device of claim 1 wherein the body includes a take-call button carried by the housing and coupled to the circuitry.

9. The device of claim 1 for use with a base wherein the body includes an electrical connector carried by the housing for docking with the base.

10. A clip-on wireless device for use with a mobile communications device by an operator wearing an article of upper-body clothing comprising a body having a housing and a clip connected to the housing, the clip being adapted for attaching the body to the article of clothing, the body being light-weight so as to permit the body to the carried on the article of clothing by the clip, an integrated circuit carried within the housing and including radio communications circuitry for communicating with the mobile communications device, an earpiece and a cable connecting the earpiece to the circuitry within the body, the housing being provided with a recess of receiving the earpiece when the earpiece is not in use.

11. The device of claim 10 wherein the recess is sized to permit the earpiece to seat entirely within the confines of the housing when the earpiece is not in use.

12. The device of claim 10 wherein the body is provided with a microphone connected to the integrated circuit.

13. The device of claim 10 wherein the body is thumb-sized.
